(19) United States
(12) Patent Application Publication
(10) Pub. No.: US 2026/0199859 A1
(43) Pub. Date: Jul. 16, 2026

(54) APPARATUS FOR SUPPLYING A CATALYST SLURRY

(71) Applicant: INEOS EUROPE AG, Vaud (CH)

(72) Inventors: Brent Walworth, Sint Niklaas (BE); Philip Van Breuseghem, Temse (BE)

(21) Appl. No.: 19/020,442

(22) Filed: Jan. 14, 2025

(51) Int. Cl. B01J 8/00; B01J 8/20

(52) U.S. Cl. CPC B01J 8/001; B01J 8/20

(57) ABSTRACT

An apparatus for supplying a catalyst slurry to a polymerisation reactor includes: (a) a catalyst day tank, for receiving catalyst from a catalyst storage vessel, and having an outlet to allow catalyst to flow out the bottom; (b) load cells on which the catalyst day tank is supported or other means for determining the weight of the contents of the catalyst day tank; (c) a catalyst feed pot, having an inlet for receiving catalyst from the catalyst day tank, which catalyst feed pot has a volume of 5 to 250 litres; (d) a catalyst mixing tank which has an inlet for catalyst from the catalyst feed pot and an inlet for diluent, and which catalyst mixing tank is a vertical cylindrical tank having a volume of at least 5m3, and includes an agitator for mixing catalyst and diluent, and (e) a reactor connected to the catalyst mixing tank.

### FIELD OF THE INVENTION

This invention relates to an apparatus, and in particular for supplying catalyst slurry to a polymerisation reactor.

### BACKGROUND OF THE INVENTION

In a typical slurry polymerization reactor, monomer, diluent and a particulate catalyst are fed to a reactor where the monomer is polymerized. The diluent does not react but the quantity of diluent supplied to the reactor is typically utilized to control solids concentration in the reactor and also to provide a convenient mechanism for introducing the particulate solid catalyst into the reactor. In typical gas phase reactions too, the particulate catalyst is generally transported to the reactor using an inert gas carrier, however a typically inert diluent may also be used where the quantity of diluent introduced can be kept in balance with the requirements for gas phase composition control. In gas phase reactions the inert diluent introduced is typically introduced to optimise the heat removal from the reaction system.

Catalyst is generally in the solid state, and fragile. In many processes, the quality of the produced product and operability of the process depends on the particle size and particle size distribution of the (generally fragile) catalyst. If the catalyst is damaged during its injection into the process, there can be disadvantageous effects on the process such as increased fines levels, changed molecular weight distribution, lowered bulk densities, etc. Generally the catalyst has to go from a low pressure (atmospheric or near atmospheric state) to a high pressure state to be able to enter the reactor (20-50 barg, but can be a much larger range). It is generally required to do this at a consistent, specific flowrate without damaging the catalyst (i.e. maintaining particle size, not crushing it, etc).

### SUMMARY OF THE INVENTION

We have developed an apparatus which avoids many of the above-mentioned problems by providing a system in which a catalyst mixing tank is supplied batchwise with catalyst and diluent, but which provides a continuous flow of catalyst slurry to a reactor and which permits accurate evaluations to be made both of the concentration of the catalyst slurry in the mixing tank and that supplied to the reactor.

Accordingly in a first aspect the present invention provides an apparatus for supplying a catalyst slurry to a polymerisation reactor, said apparatus comprising:

(a) a catalyst day tank, for receiving catalyst from a catalyst storage vessel, and which catalyst day tank has an outlet to allow catalyst to flow out the bottom;

(b) load cells on which the catalyst day tank is supported or other means for determining the weight of the contents of the catalyst day tank;

(c) a catalyst feed pot, having an inlet for receiving catalyst from the catalyst day tank, which catalyst feed pot further has a volume of 5 to 250 litres;

(d) a catalyst mixing tank which has an inlet for catalyst from the catalyst feed pot and an inlet for diluent, and which catalyst mixing tank is a vertical cylindrical tank having a volume of at least 5m³, and further comprises an agitator for mixing catalyst and diluent, and

(e) a reactor connected to the catalyst mixing tank.

### BRIEF DESCRIPTION OF DRAWING

The Figure shows a diagram of an apparatus for supplying catalyst slurry to a polymerisation reactor.

### DETAILED DESCRIPTION OF THE INVENTION

The vessels and apparatus employed in the apparatus as set out above can be defined as follows:

Catalyst storage vessel (catalyst carrier): This vessel is upstream of the catalyst day tank and supplies catalyst thereto. The catalyst storage vessel is generally designed to handle the catalyst in the form it comes from a catalyst preparation unit. As such, it is thus adapted to the physical state in which the catalyst arrives at the plant before feeding. In embodiments it may be a portable vessel in which catalyst has been transported to the plant.

Dry catalyst carrier: This is a version of a catalyst storage vessel adapted for catalyst in the dry state. Typically, this is relatively a simple vessel designed to have or allow an overpressure of a dry inert gas (usually nitrogen) to avoid atmospheric contamination of the catalyst. The tank may have a cone bottom to facilitate the flow of solid catalyst out of the bottom.

Catalyst day tank: This tank receives catalyst from the catalyst storage vessel, and has an outlet to allow solid catalyst to flow out the bottom. The tank is usually under dry inert gas overpressure (usually nitrogen) to protect the catalyst from atmospheric contamination. Means are provided for determining the weight of the contents of the catalyst day tank. In one embodiment, the tank is supported on load cells so that the tank and its contents can be weighed. In other embodiments, the catalyst day tank is provided with a different means for determining the weight of the contents of the catalyst day tank. An example would be a level measurement, which provides a value which can be converted to a weight measurement for the contents, for example using the density thereof. The purpose of the catalyst day tank is to receive catalyst from the catalyst storage vessel and to provide feed, such as gravity feed, of the solid catalyst into the feed pot, the amount of which can be determined by the difference in the weight of the contents before and after discharge. The catalyst day tank may have a cone bottom but this is not necessary.

Catalyst Feed Pot: The catalyst feed pot is a relatively small vessel. In the present invention its volume is 5 to 250 litres, more often 20 to 200 litres. The preferred volume within this range depend on the properties of the catalyst being fed, the production process and production rate required. This vessel preferably has a cone top and bottom. The cone bottom can facilitate the flow of catalyst out of the tank. The cone top is designed to maximise filling of the solid catalyst.

Catalyst mixing tank: This tank is a vertical cylindrical tank which has an inlet for catalyst from the catalyst feed pot and an inlet for diluent. The tank also has an agitator for mixing catalyst and diluent. The agitator is preferably designed to have a minimum of mechanical impact on the catalyst. In the present invention the tank has a volume of at least 5m³. The volume of the mixing tank is usually less than 15m³. Preferably the volume of the mixing tank is at least 7m³, such as in the range 8 to 12m³.

Reactor: The reactor may be any suitable reactor for the polymerisation of olefins. Examples include slurry-phase, solution-phase and gas-phase reactors, such as a slurry loop reactor, and gas-phase fluidized bed or stirred bed reactor.

The apparatus may, and preferably does, also comprise one or other of the following:

Buffer vessel: This is a small vertical cylindrical tank , typically with a cone bottom, and which may be provided/located between the catalyst mixing tank and the reactor. The tank may have a pressure measurement and level indicator. Its purpose is to mix the slurry from the mixing tank with additional (fresh or recycled) diluent before the resultant slurry is pumped to the reactor. It is optionally employed when a catalyst feed pump is used.

Catalyst Feed Pump: This pump is optional and can be used to pump catalyst slurry into the reactor. (Alternatively, an overpressure in the slurry tank can be used to push catalyst into the reactor.) The catalyst feed pump, when present, may be a diaphragm pump with suction inlet on top and discharge on the bottom. In preferred options the valves of any such pump have to be spring loaded to ensure that they do not hang open if solid catalyst gets between the valve and the seat.

Essentially the apparatus consists of two systems operating together to provide the catalyst to the reactor: a batch catalyst refill and dilution system feeding a mixing tank, and a continuous catalyst slurry flow out of the mixing tank to the reactor (optionally, and normally, through a catalyst pump).

There are several ways to operate the apparatus, which generally involves batch refilling of the catalyst mixing tank from the catalyst feed pot when the level (volume) of catalyst slurry in the mixing tank is relatively low.

The initial slurry concentration in the mixing tank is known from the catalyst mass and diluent volume measured previously.

Catalyst is added to the mixing tank from the catalyst feed pot. The mass of added catalyst is determined from the mass of catalyst which is discharged into the tank from the catalyst feed pot, and in particular from the catalyst day tank. Additional diluent is added via the diluent inlet to ensure that the catalyst concentration after the refill is the same as it was initially. More specifically, the concentration is updated during the steps of refilling of catalyst and dilution with additional diluent as follows.

Following catalyst refill, the new mass of catalyst in the mixing tank is determined by directly measuring that mass discharged into it, and adding this to the mass of catalyst present in the mixing tank before the refill.

With the volume of diluent in the tank known, this new mass is used to update the slurry concentration.

A measured amount of diluent is then added until the concentration reduces to its initial level.

Once dilution is complete, the new catalyst slurry concentration is recorded to be used in calculations for the next refill. In a preferred embodiment, the mass of catalyst is measured prior to mixing it with any diluent.

It is also possible to provide a means to measure the actual catalyst mass flow discharged to the reactor, for example by measuring the density and mass flow rate out of the mixing tank. The apparatus may comprise, for example, a Coriolis flowmeter. By calculating the theoretical density of the diluent at the temperature and pressure of the mixing tank, and comparing this to the measured density of the slurry in the flowmeter, the instantaneous mass flow rate of catalyst can be calculated. Although the invention is particularly useful for slurry polymerisation reactions, it can also be used for gas phase polymerisations, in which case the amount of fresh diluent used is typically much less, although the principles of the invention remain the same.

Where it is necessary for efficiency and/or mass balance requirements to minimize the quantity of fresh diluent used in this process it is possible to use as the diluent make-up comonomer or monomer lean recycled condensibles recovered from either the reaction loop or the degassing system of the polymerisation reactor. The main constraint on such use is the avoidance of any fouling as a result of polymerisation of the catalyst. Such recycled streams have also been found to be suitable to assist the conveyance of the diluted catalyst stream to the reactor after it exits the mixing tank.

The refill of the catalyst mixing tank may in particular be operated as follows:

Preparation of the day tank: A solid (dry) catalyst is introduced into a dry catalyst storage vessel. The catalyst storage vessel is connected to the catalyst day tank. The catalyst is pneumatically transferred to the day tank (day tank is usually above the storage vessel). Care has to be taken to use low pressure and flowrates during the pneumatic transfer or the catalyst can be damaged. Once the transfer is finished, the catalyst storage vessel is disconnected and removed to the catalyst preparation area. The weight of the contents in the catalyst day tank is determined and recorded. The day tank is under a light overpressure of dry inert gas (nitrogen at about 4 barg, but the pressure can vary significantly).

When operating with dry catalysts, there are two different modes of refill and dilution of the mixing tank: so-called “dry/dry” and “dry/wet”.

Dry/Dry mode: In this mode of operation, catalyst begins in the catalyst day tank under nitrogen at about 4.0 barg. From here the catalyst feed pot is refilled with dry catalyst, the weight of which is determined from the weight change of the contents of the catalyst day tank, and pneumatically conveyed to the mixing tank typically using a flush of nitrogen. A measured volume of diluent is then added direct to the mixing tank. The advantage of dry/dry mode is that refill of the catalyst feed pot is generally excellent since the catalyst is dry at all times; and it is in theory the best for valve life. A potential disadvantage is that the catalyst is not properly wetted in the mixing tank and can form into lumps or can be blown out the nitrogen vent of the mixing tank during pneumatic conveying.

Dry/Wet mode: In this mode of operation a weighed amount of dry catalyst is discharged into the catalyst feed pot as in dry/dry mode, but the catalyst is then wetted with a small amount of diluent, which is added slowly, preferably from the bottom of the feed pot. The wetted catalyst is then flushed into the mixing tank using a measured amount of diluent. All of the diluent added to the mixing tank can be used for flushing, or some of the diluent can be added direct to the mixing tank (and the quantity also measured), in which case both lots of diluent are used for the concentration calculation. The advantage of dry/wet mode is that the catalyst is wetted in a slow and controlled manner. Potential disadvantages with this mode of operation are that the catalyst feed pot is not correctly refilled because of liquid diluent which makes the catalyst stick or fluidised on refill.

Mixing tank mass balance and catalyst flow control: In order to maintain consistent catalyst feed conditions to the reactor, a continuous mass balance of catalyst and diluent is calculated in the mixing tank. This mass balance is used to calculate the slurry concentration in the mixing tank (g/l), and this concentration is used to adjust the catalyst flowrate such that a constant catalyst flow to the reactor is maintained, even during dilution of the mixing tank with additional diluent.

There are two aspects to the mass balance: the amount of catalyst and the amount of diluent. Diluent volume can be determined by measuring the level of slurry in the mixing tank. The volume of catalyst in the slurry is ignored. (Diluent volume can also be determined by totalizing diluent flow during dilution and subtracting the catalyst slurry flow which has left the mixing tank since the last refill.) As described previously, the method to determine catalyst mass is to check the weight of catalyst which actually enters the catalyst feed pot by measuring weight loss in the catalyst day tank. The weight loss of the catalyst day tank during catalyst charge pot filling indicates the amount of catalyst which will eventually be injected into the catalyst mixing tank during refill. This makes it possible to achieve a true mass balance system for the catalyst.

Calculation of slurry concentration in mixing tank: As an example, if a refill is started at 50% level in the mixing tank, the following is calculated.

First, the volume of diluent and mass of catalyst in the vessel before refill is determined. This catalyst mixing tank diluent volume is then used to calculate the mass of catalyst in the mixing tank using the present slurry concentration. For example, if there are 3 m³ of slurry in the mixing tank before refill (50% fill in a 6m³ mixing tank), and a slurry concentration of 3 g/l, then the mass of catalyst before refill would be: 3 m³ * (1000 l/m³) * 3 g/l = 9000g of catalyst in the mixing tank.

Both the starting volume and starting catalyst mass are noted.

Once catalyst refill begins, the mass of catalyst injected into the mixing tank is determined as previously mentioned, and this amount added to the above-calculated mass of catalyst present before the refill. For example, 1800 g of catalyst may be added. This weight of catalyst is verified by the loss in weight of the catalyst day tank during refill.

In this case, the total mass of catalyst in the mixing tank becomes 1800 g injected + 9000g existing mass = 10800g.

This new mass is then used to continuously update the slurry concentration. Until diluent is added the concentration is obviously higher than the set point of 3 g/l:

10800 g of catalyst / 3000 l diluent = 3.6 g/l catalyst slurry concentration.

Dilution of the slurry in the mixing tank is started and continues until the catalyst concentration reaches its set point. In this case, if the catalyst concentration set point is 3 g/l, the diluent will refill until the total volume of slurry in the mixing tank is 3600 litres: (10800/3600 = 3 g/l.)

This example corresponds to a fill to 60% of the total volume of the mixing tank. It will be apparent that a larger fill can be obtained by repeating the above steps or by adding a larger amount of catalyst followed by a corresponding larger amount of diluent. Preferably a single fill is performed each time, with at least 15 minutes before a fill is performed again. Typically, the fill may be repeated no more frequently than 3 times per hour and no less frequently than once every 3 hours, although the specific frequency will depend on the properties of the catalyst and the properties of the slurry liquid being used. (And usually the fill will be repeated on a frequency between 50% of the average residence time and 10% of the average residence time.)

Once refill is complete, the catalyst slurry concentration is saved in a register to be used for calculations for the next refill.

Note in this case, it has been assumed that the refill is relatively fast, and the fact that some of the slurry in the mixing tank is discharged to the reactor during the refilling operation is ignored. (If necessary, catalyst slurry discharge from the mixing tank can be paused during this operation. For example, if a buffer vessel as described further below is present then the volume of catalyst slurry present therein can be used to feed catalyst to the reactor during the refilling of the mixing tank described above.)

It should also be noted that although in this example catalyst has been added first, followed by dilution, the opposite can also work. It will be seen that so long as the existing slurry concentration is known together with the mass of catalyst in the feed pot (which will all be added to the mixing tank), the amount of diluent to be added is immediately calculable.

Continuous catalyst feed from the catalyst mixing tank to the reactor: Catalyst is preferably fed (discharged) continuously from the mixing tank to the reactor. This part of the process is characterised by the following, and is the same for all types of catalyst and modes of refill/dilution:

• Flow control of the catalyst slurry out of the mixing tank via a control valve

• (Optional) Addition of catalyst diluent (typically before the optional catalyst pump). This improves the flow properties of the catalyst in the line to the reactor and reduces the chance of catalyst damage in the (optional) catalyst feed pump.

• (Optional, necessary if the mixing tank pressure is less than the reactor pressure) Pumping of the diluted catalyst slurry, preferably with a vertically oriented diaphragm pump, preferably with the suction valve on top and the discharge valve on the bottom.

During refill of the mixing tank, it has been shown above that the slurry concentration temporarily changes until refill of both catalyst and diluent is complete. It was noted above that catalyst slurry discharge from the mixing vessel can be paused during the refill. However, it is also possible to continue discharge during the refill.

In the case where catalyst is added first, the concentration will briefly rise before falling back to the set level once diluent addition is complete. Because the concentration can be accurately calculated, the flow control of slurry out of the mixing tank to the reactor can be temporarily adjusted so as to maintain a constant mass flow of catalyst to the reactor. Thus in the case where catalyst is added to the mixing tank first, the rise in mixing tank concentration is compensated by a corresponding reduction in flow rate out of the mixing tank such that the mass of catalyst passing to the reactor remains unchanged. The extent of such variation depends on the relative sizing of the various components of the system, however even when relatively large variations of slurry concentration are experienced in the catalyst mixing tank (e.g. slurry concentration increases of up to 30%), the accurate knowledge of the actual slurry concentration provided by the invention allows for satisfactory control of the actual catalyst flowrate to the polymerization reactor.

One advantage of this maintenance of a constant catalyst mass flow rate to the reactor is that the proportion of slurry in the mixing tank which is renewed during each refill can be significant. This proportion depends partly on the working concentration of the slurry in the mixing tank, and also on the maximum possible peak concentration during refilling. These in turn are a function of catalyst properties such as bulk density, particle density, diluent density, agitator interaction with slurry (too high a concentration requires excessively high agitator power which can lead to catalyst damage), and catalyst particle fragility. Another limiting factor is the lowest controllable flow which can reliably pass through the control valve at the outlet of the mixing tank to the reactor. If the peak slurry concentration during refilling is too high, the agitator may have difficulty adequately distributing the catalyst through the slurry.

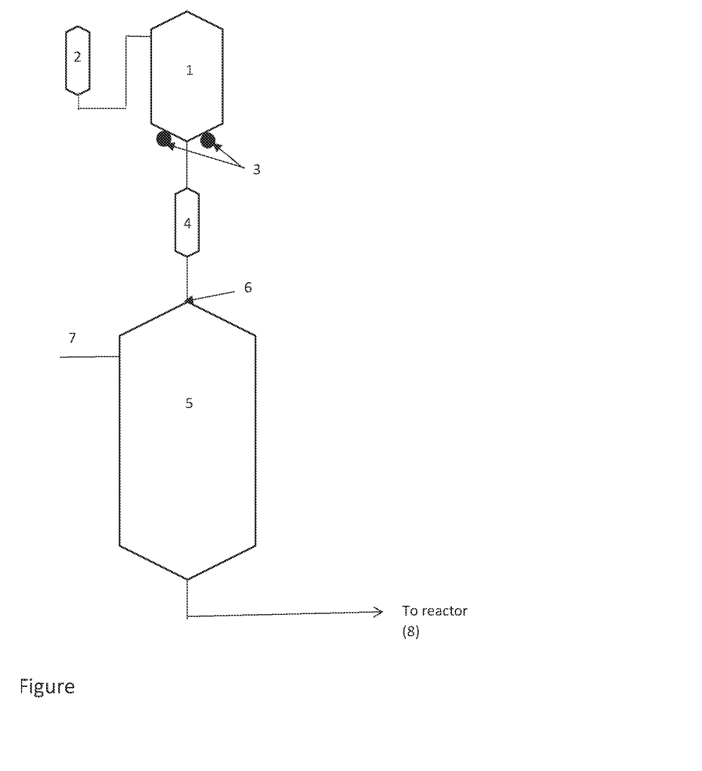

The apparatus is illustrated schematically in FIG. 1 which shows an apparatus comprising a catalyst day tank (1), for receiving catalyst from a catalyst storage vessel (2). In this particular example the catalyst day tank (1) is supported on load cells (3), which provide the means for determining the weight of the contents. FIG. 1 also shows a catalyst feed pot (4) and a catalyst mixing tank (5) which has an inlet (6) for catalyst from the catalyst feed pot (5) and an inlet (7) for diluent. The catalyst mixing tank (7) is connected to a reactor (8)(not shown).

1. Apparatus for supplying a catalyst slurry to a polymerisation reactor, said apparatus comprising:
(a) a catalyst day tank, for receiving a catalyst from a catalyst storage vessel, and the catalyst day tank has an outlet to allow the catalyst to flow out a bottom of the catalyst day tank;
(b) a plurality of load cells on which the catalyst day tank is supported or other means for determining a weight of contents of the catalyst day tank;
(c) a catalyst feed pot, having an inlet for receiving the catalyst from the catalyst day tank, wherein the catalyst feed pot further has a volume of 5 to 250 litres;
(d) a catalyst mixing tank which has an inlet for the catalyst from the catalyst feed pot and an inlet for a diluent, and the catalyst mixing tank is a vertical cylindrical tank having a volume of at least 5m³ and further comprises an agitator for mixing the catalyst and the diluent, and
(e) a reactor connected to the catalyst mixing tank.

2. The apparatus according to claim 1 wherein the apparatus further comprises a buffer vessel, located between the catalyst mixing tank and the reactor, wherein the buffer vessel has an inlet for the catalyst from the catalyst mixing tank and an inlet for the diluent, and the buffer vessel is a vertical cylindrical tank with a cone bottom, a pressure measurement and a level indicator.

3. The apparatus according to claim 2 further comprising a catalyst feed pump, located after the buffer vessel and prior to the polymerisation reactor.

4. The apparatus according to claim 3 wherein the catalyst feed pump is a diaphragm pump with a suction inlet on top and a discharge on the bottom.
